(19) United States
(12) Patent Application Publication
(10) Pub. No.: US 2008/0279452 A1
(43) Pub. Date: Nov. 13, 2008

(54) Virtual Earth Image Isolation System

(76) Inventors: Michael Keane, Santa Barbara, CA (US); James J. Saccacio, Coto de Caza, CA (US)

Correspondence Address: KOPPEL, PATRICK & HEYBL, 555 ST. CHARLES DRIVE, SUITE 107, THOUSAND OAKS, CA, 91360, US

(21) Appl. No.: 12/058,436

(22) Filed: Mar. 28, 2008

Related U.S. Application Data
(60) Provisional application No. 60/909,348, filed on Mar. 30, 2007.

(51) Int. Cl. G06K 9/34

(52) U.S. Cl. 382/173

(57) ABSTRACT

A system for isolating an image of a target property provides a user interface apparatus for receiving a property identifier. A virtual tile retriever is provided for retrieving a set of virtual tiles from a source of virtual tile images using the property identifier. An image isolator provides for generating an isolated image of the target property from the set of virtual tiles. An output device provides for displaying said isolated image of the target property.

This application claims the benefit of provisional application No. 60/909,348 to Michael Keane filed on Mar. 30, 2007.

### BACKGROUND OF THE INVENTION

1. Field of the Invention

The invention relates to methods to isolate, enlarge and manipulate images of individual pieces of real estate from wider area satellite images where that wider image may include multiple pieces of real property or surrounding topography. The isolated image can then be displayed in a user friendly manner, such as print or on a screen display, particularly for marketing purposes and for comparison with other comparable pieces of real estate for establishing a comparable market value or assembling a comprehensive real estate listing including text and images.

2. Description of the Related Art

Various web services such as Microsoft's Virtual Earth allow for the rendering of aerial or oblique imagery, which Microsoft calls “Aerial” or “Bird's Eye” imagery. This provides a high resolution photo of an area taken from a low flying airplane. The images are stored in units referred to as tiles, each tile being a single picture of a defined area. Example of such publicly available images can be viewed on www.zillow.com. While these tiles provide images of an area, that area includes multiple pieces of real estate, individual properties are not presented in a meaningful way for the purposes set forth herein and they must be further manipulated in order to isolate individual pieces of real estate.

### SUMMARY OF THE INVENTION

A system for isolating an image provides a user interface apparatus for receiving a property identifier. A virtual tile retriever is provided for retrieving a set of virtual tiles from a virtual tile server using the property identifier. An image isolator provides for generating an isolated image for a desired structure. An output device is provided for displaying the isolated image along with additional property data.

### BRIEF DESCRIPTION OF THE DRAWINGS

FIG. 1 illustrates one embodiment with virtual tiles retrieved based on user input.

FIG. 2 illustrates an embodiment of a method for isolating and displaying an image.

FIG. 3 illustrates one embodiment of horizontal and vertical offsets used to isolate an image.

FIG. 4 illustrates one embodiment displaying an isolated image.

FIG. 5 is a list of a selection of the potential modules that may be used in one embodiment.

FIG. 6 shows a desired structure image in a four tile image.

FIG. 7 shows an example of an isolated image of the desired structured image.

FIG. 8 shows another desired structure image in another four tile image.

FIG. 9 shows another isolated image of the desired structure image.

### DETAILED DESCRIPTION OF THE INVENTION

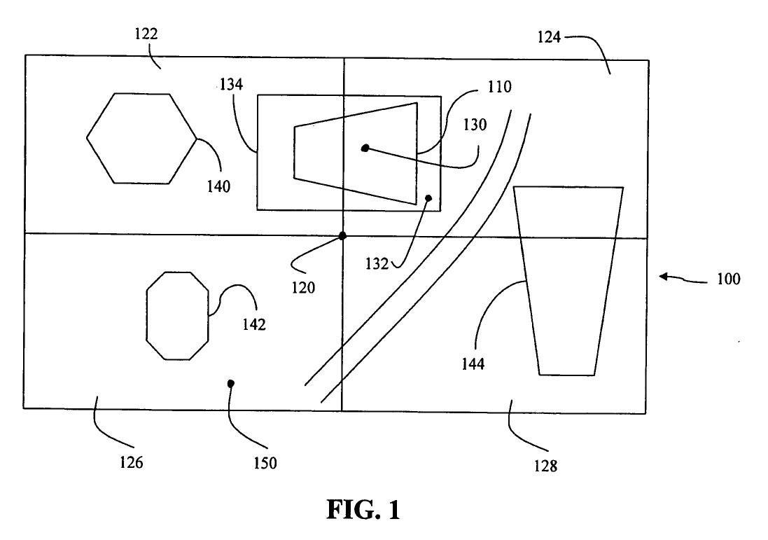

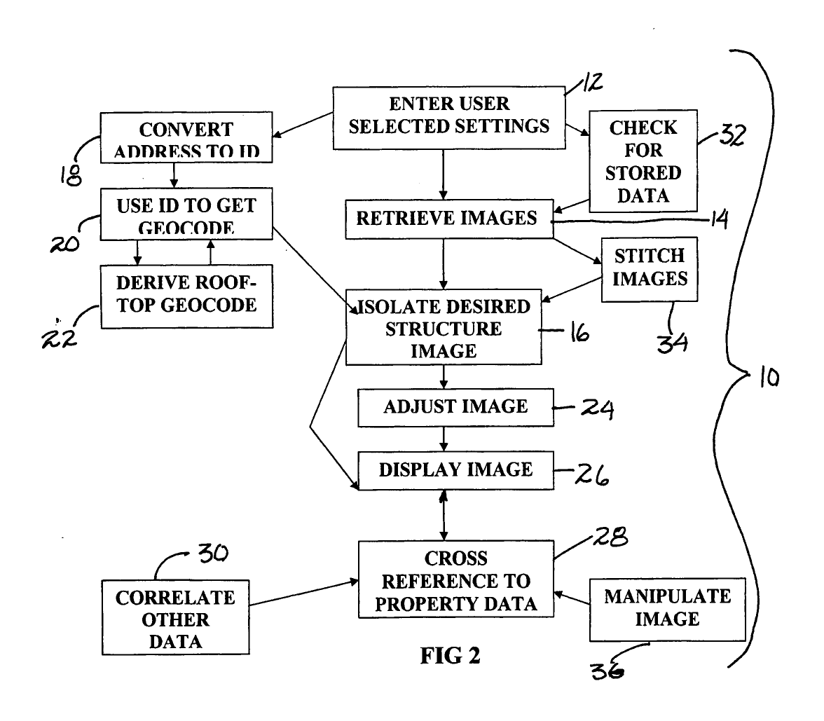

FIGS. 1 and 2 show one embodiment of a display 100 of the invention retrieved by a user providing a street address, or other physical address locator information, to an input interface of the virtual image isolation system 10 incorporating features of the invention. The input interface can be a Graphical User Interface (GUI) displayed on a screen, for example, or a device capable of providing such information automatically. In the preferred embodiment, the information used to generally a display 100 is retrieved from Microsoft's Virtual Earth web service. Other services providing similar information, functionality and display capabilities can be used.

A display 100 shows images based on several user-selectable settings, which are commonly used in various mapping web services such as Microsoft's Virtual Earth. Some of these settings can include an image zoom level, an image view type, an image viewing direction, an image angle, and/or an image resolution. Other standard image viewing properties may also be set by the user or used to display the image. Other image view types are also possible; the invention is not limited or bound to these views. The user typically selects these settings through the graphical user interface. Whenever a user-selectable setting is not specified, the virtual image isolation system uses a convenient default value, or uses values previously used/provided. These default values may themselves be changed by the user, and can be stored either in a flat file, database, or as a web browser cookie.

One user-selectable setting provided in the preferred embodiment is the image zoom level which represents how “magnified” the image appears on the display 100. Typically, the quality of the image produced at a maximum zoom level is limited only by the quality/resolution of the original image photograph. The user can typically select how much to zoom in/out to obtain the desired image detail.

Another user-selectable setting provided in the preferred embodiment is the image view type, which can include different perspective views such as an aerial view, birds eye view, or a street view. Aerial views are typically those that show an image as viewed from above it, i.e. looking straight down. When viewing structures in aerial view the image will typically show the roofs of the buildings. A birds-eye view, on the other hand, typically shows one or more side-views of an image as seen from the air. When viewing structures in birds-eye view, for example, the display 100 typically shows one or more sides of buildings/structures as seen from the air. Street view, on the other hand, typically shows an image as seen from street-level. When viewing structures in street view, the display 100 typically can show one or more sides of the building at ground level.

Another user-selectable setting is the viewing direction. This setting allows the user to select which direction the observer is “facing” in the image shown in display 100. Suitable viewing directions can include North, South, East, and West, or any direction in between. As an example, when using the North viewing direction in a birds-eye view for a particular structure at a certain street address, the display 100 would show a perspective view as seen by an individual facing north, from an elevated position, thereby showing at least some of the south facing portions of buildings.

Another user-selectable setting available in some embodiments is the viewing angle. The viewing angle is typically used in birds-eye or street level view, and allows the display image 100 to pan up and down, thereby adjusting the angle above ground level from which a particular image is viewed. Additionally, the user may also select an image resolution.

Once the user-selectable settings 12 are specified, the virtual earth image isolation system retrieves and displays the images 14 corresponding to those settings. The images displayed typically comprise a set of virtual tiles typically having first, second, third, and fourth virtual tiles 122, 124, 126 and 128, respectively, each of which shows an image corresponding to the inputted street address and the surrounding area that corresponds to the user-selected or default view settings. In one embodiment, where each tile typically comprises 256 pixels, a four tile display will include a total of 1024 pixels. The virtual tiles 122, 124, 126 and 128 are typically the product of one or more aerial photographs taken and stored on a virtual tile server. The number, shape and configuration of the set of virtual tiles can vary, as can the pixel count per tile; four rectangular/square shaped tiles having 256 pixels per tile are shown for illustrative purposes only. In another embodiment, for example, the set of virtual tiles can include six or two virtual tiles, and/or the number of pixels per tile can vary. Additionally, image enhancing techniques commonly known in the art can be used to adjust the image.

The street address provided by the user typically corresponds to a specific desired structure image 110, which the user desires to view or retrieve. Although this desired structure image 110 appears somewhere in the display 100, it is typically not displayed or centered with respect to a display center 120, and is also usually shown among other surrounding structure images such as first, second and third surrounding structure images 140, 142, and 144, respectively. The number of surrounding structure images returned by the virtual tile server can vary widely, and is not limited to the three depicted in FIG. 1. The lack of centering and the clutter of the surrounding structure images 140, 142 and 144 can reduce the usefulness of displaying the desired structure image 110, particularly in displays or printouts whose purpose is to focus attention on, emphasize, and/or display only a particular structure.

To address these issues, the virtual image isolation system 10 incorporating features of the invention preferably isolates and adjusts the image 14 so that the desired structure image 130 is shown in the display center 120, and also removes or minimizes the number of the surrounding structure images 140, 142 and 144, for example, that are displayed, printed or otherwise retrieved. To produce this preferred display, the virtual image isolation system 10 in one embodiment converts the physical address entered by a user into a property ID 18 that uniquely identifies a particular address by looking the property ID up in a database. The property ID may then be used to obtain a Geospatial Entity Object Code (“geocode”) from the same or different database, allowing for specific/detailed coordinates that more precisely identify the location of the desired structure 20. The property address, property ID and corresponding geocode can be correlated with one another and stored in and retrieved from a database. In another embodiment, the user-entered information such as street address, etc. is used directly to obtain the geocode, without having to first obtain a property ID 18.

A geocode is a commonly used representation format of a geospatial coordinate measurement used to provide a standard representation of an exact geospatial point location at, below, above the surface of the earth, typically at a specified instant of time. In one embodiment, the geocode information comprises longitude and latitude information such as degrees, minutes and seconds corresponding to the location of an object such as a building or other structure. In other embodiments, other information can also be used as part of the geocode for an object, including, but not limited to altitude. The geocode information is preferably stored and retrieved from an updatable database, but can also be retrieved from other devices, even in real time.

In the preferred embodiment, the two types of geocodes typically stored and used to adjust the image include a rooftop geocode 130, and/or a property geocode 132, which corresponds to the location of a desired property image 134. Other types of geocodes may also be used.

The rooftop geocode 130 identifies an approximate center of the roof of the desired structure 22 image 110, and is the preferred geocode type for use in the virtual earth image isolation system.

The virtual earth image isolation system 10 first checks for a rooftop geocode 130. When the rooftop geocode 130 is unavailable, the property geocode 132 may be used to derive the rooftop geocode. The property geocode 132 typically identifies the location of some artifact on the property itself, such as a postal mailbox, or the center front of the property. The property geocode 132 can be used to calculate the approximate center of the roof of the desired structure image 110. To perform this calculation, the virtual earth image isolation system 10 can obtain information about the size of the property and the size and location of the desired structure image 110 on the property. This information is typically stored in a database, for example, at Realtytrac, Inc. Based on this information and the zoom level selected by the user, the virtual earth image isolation system 10 calculates the approximate location of the rooftop geocode 130.

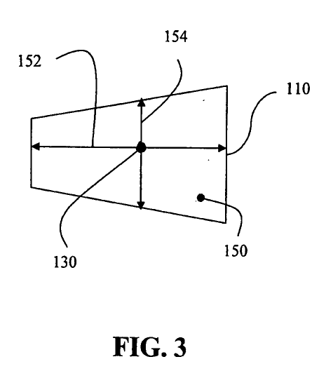

FIG. 3 shows an embodiment in which the rooftop geocode 130 is used to adjust the displayed image 24. Since the rooftop geocode 130 already defines the approximate rooftop center of the desired structure image 110, the virtual earth image isolation system uses it along with a horizontal and vertical offset 152 and 154, respectively, to display as much of the desired structure image 110 as possible while excluding the surrounding structures (not shown in FIG. 3). Other types of offsets may also be used in other embodiments.

In one embodiment, the horizontal and vertical offsets 152 and 154 can be preset values of a fixed number of pixels and/or distance. The fixed number of pixels/distance can differ for different zoom levels and/or other user-selectable information.

In another embodiment, the horizontal and vertical offsets 152 and 154 can be pre-calculated for each zoom level and/or other user-selectable information, and then stored in a database for retrieval. Each tile or set of tiles can contain a value that indicates the distance from one end of the tile to the other for a particular zoom level. Different zoom levels can have different scales and hence different distances. For example, at zoom level 5, the distance along a length of a tile may be 5 meters, whereas at a lesser zoom level 1, the distance along the length of the tile may be 20 meters. Since the number of pixels per tile is known, the number of pixels per unit of distance can be calculated by dividing the number of pixels across the tile by the known distance across the tile. Alternatively, the tile may explicitly contain a pixel/distance value, or the tile may provide some other value from which the pixel per distance value can be derived.

In another embodiment, the number of pixels per distance can be calculated using other means. In one embodiment, the virtual earth image isolation system 10 sets the horizontal and vertical offsets 152 and 154 to a fixed distance value. For example, it may be known that the average structure has 20×20 meter foundation length and width, respectively. These distances can be converted into the number of pixels for that particular zoom level as discussed previously, and the number of pixels can then be used as the horizontal and vertical offsets 152 and 154 and stored in a database as preset offsets.

In yet another embodiment, the horizontal and vertical offsets 152 and 154 distances can be determined by using the actual dimensions of the desired structure 110 instead of using the dimensions for an average structure. Once the horizontal and vertical offsets 152 and 154 are determined, the virtual earth image isolation system 10 can load the appropriate pixels into a memory buffer or array to store the desired structure image 110.

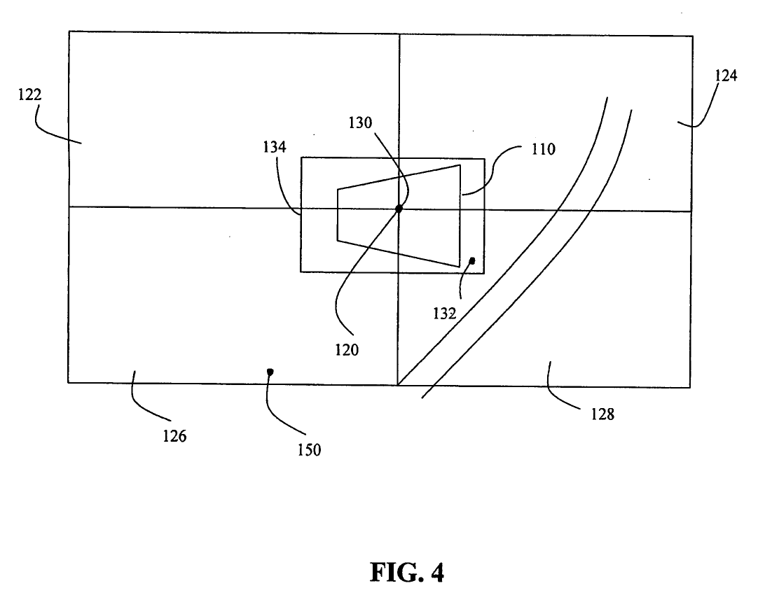

The image can then be displayed 26, printed or output to a screen, paper, or other viewing implement such that the desired structure image 110 is centered in the display as shown in FIG. 4, and is an isolated image. Preferably, the rooftop geocode 130 coincides with the display center 120. However, this is not required. Additionally, the presence of any surrounding structures is preferably minimized or eliminated, as also shown in FIG. 4.

In one embodiment, the updatable database can include other information that correlates with a particular geocode and which is displayed alongside the desired structure image 110. For example, a database available from RealtyTrac, Inc. can provide a nationwide listing of properties available for purchase including Pre-Foreclosures, Bank Foreclosures, For Sale by Owner, Foreclosed Homes via Auction, New Homes and MLS Listings, etc. The RealtyTrac Inc. data services can include pre-foreclosure information, such as Notices of Default, Trustee's Sales, and lender owned information, such as REO Properties and Sheriff's Auction. In addition, their services also include Real Estate MLS listings, MLS Online Search and Daily Notifications for selected searches on every state. Thus, desired structure image 110 can also be cross referenced with data for that property 28, such as data provided by local governmental agencies or included in real estate data bases such as real estate multiple listing services (MLS).

Other data may also be correlated 30 with the images displayed. For example, maps with labeled roads and/or structures, etc. may be incorporated into and/or onto the displayed images. Additionally, the user through the GUI can also mark or highlight portions of the displayed image, to drop a “pin” at a specific geocode location, for example, for future reference.

In one embodiment, some of the main steps in the software system and data processing scheme for the image capture and manipulation process incorporating features of the invention include, but are not limited to:
1. An image request including a property ID is coordinated with property data listed in the real property database. A preferred image request includes specific size, scale, resolution, and orientation parameters. In the absence of these parameters the system software provides a default set of image parameters to be used.
2. Any previously stored rooftop or property geocode (latitude and longitude) for the property is retrieved from the database 32. If a previously stored rooftop geocode is not available, the software system uses existing geocode services to obtain the geocode using the street address of the property.
3. Using the latitude and longitude of a property the tiles which contain images of that property are obtained from the Microsoft Virtual Earth service, or comparable services.
4. If necessary, if the property is on more then one tile, the tiles are “stitched” together 34 to form one master image that contains the entire property and surrounding area.
5. Once the stitched image has been created the area of the master image that contains the property is isolated and that area is cropped to create an image that contains primarily only the target property. The cropped image is created based on the parameters (size, scale, resolution and orientation) set in step 1.
6. Once the single property image has been created, that image is rendered as a binary stream which can be further manipulated and provided as a formatted image stream.

Some features of the system and software include, for example:
1. The ability to find all the Virtual Earth Tiles that contain a particular property.
2. The ability to combine or superimpose Virtual Earth Tiles from multiple sources, all of which contain the particular property.
3. The ability to “stitch” Virtual Earth Tiles together to form a “master image”.
4. The ability to crop the “master image” into a target image that just contains primarily that property.
5. The ability to render images at varying resolutions, scales, sizes, and orientations dynamically.
6. The ability to place an icon or “pin” in the image which identifies the exact geocode point for the property, and
7. The ability to further manipulate that image to provide views of the property from different angles and different directions 36.

A key enhancement added by the invention is the ability to isolate a single property based solely on Street Address or geocode and return that image to the user as a single image stream for viewing and further manipulation.

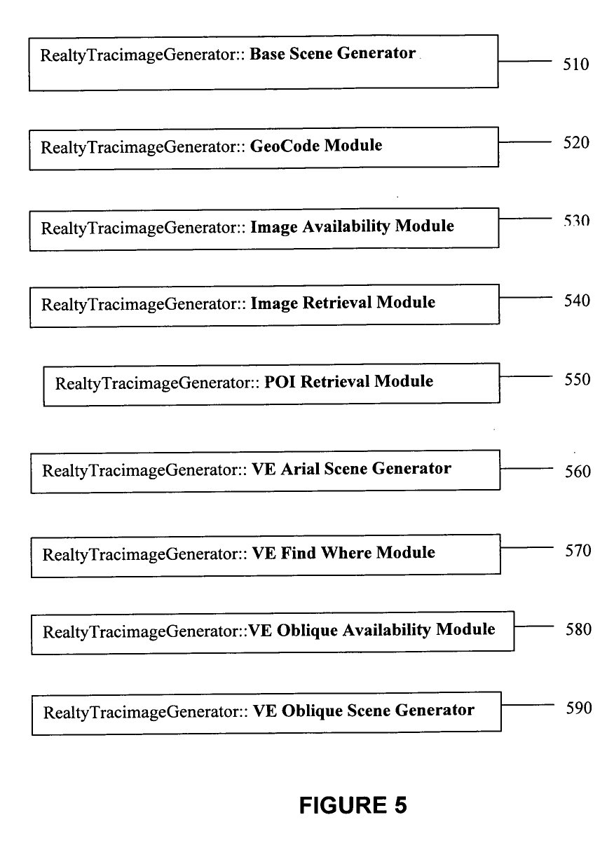

Some of the components of the system are shown in FIG. 5. Some or all of these components may be included in the virtual isolation system 10 and can be selected alternatively or in combination. These components can vary, and the system is not limited to the components shown. For example, a base scene generator 510 can be used to store and/or manage a base scene, which can include any number of images, that in one embodiment can be laid over or under a retrieved image. A geocode module 520 can be used to store and/or manage all geocode information. An image availability module 530 can be used to determine the availability of an image from the virtual tile server or other sources. An image retrieval module 540 can be used to store and/or manage obtaining images from the tile server. Other modules can be used to manage and store other features, such as the POI retrieval module 550, VE aerial scene generator 560, VE find where module 570, VE oblique availability module 580, and VE oblique scene generator 590.

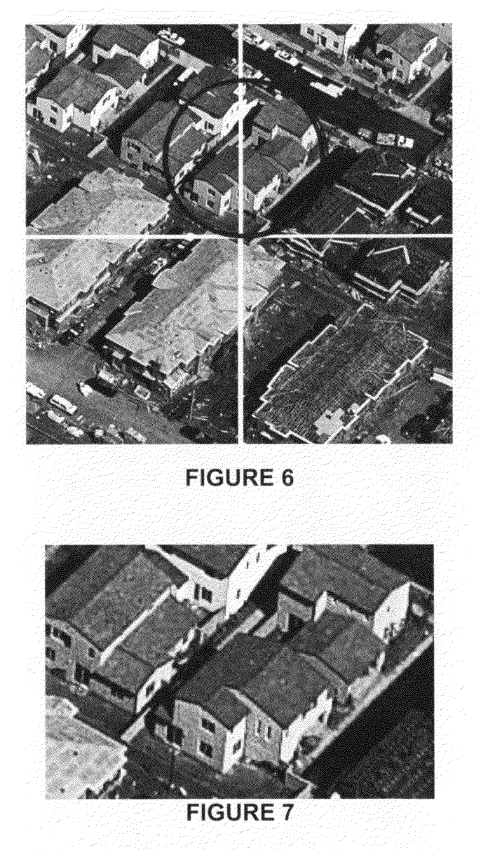

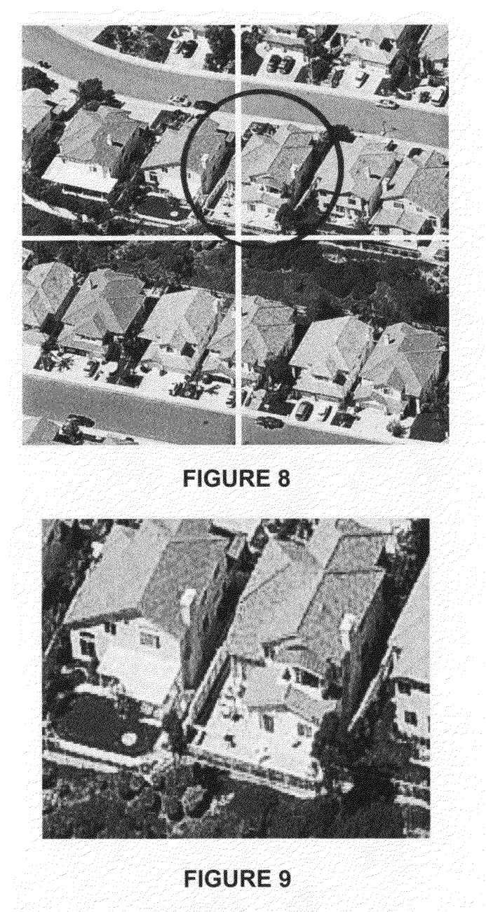

FIGS. 6 and 8 are examples of images downloaded from Microsoft's Virtual Earth web service. Each shows four tiles. The target property is identified by the circled area drawn on the image. This is an example of a publicly available image that includes a target property.

FIGS. 7 and 9 show images of the target property circled in each of FIGS. 6 and 8, respectively. In one embodiment, the tiles in each of FIGS. 6 and 8 can be stitched and cropped using the software and system incorporating features of the embodiment as described herein. The resultant image can then be converted into transportable binary code and further manipulated to show different views of the target property and enhanced.

In one embodiment, a method to convert an image such as that shown in FIGS. 7 and 9 can include the following:

a) Create an empty array of bitmaps to contain the tile images,

b) Retrieve tile images as byte arrays,

c) Convert the byte arrays to bitmaps and store in an image array,

d) Create an empty bitmap with a minimum width equal to the number of tiles in each row multiplied by the pixel width of an individual tile and a minimum height equal to the number of rows multiplied by the pixel height of an individual tile,

e) Draw the contents of the bitmap array into the empty bitmap,

f) Create a rectangle the size of the desired output image and clone the bitmap into that rectangle,

g) Create a final image by removing all parts of the bitmap not contained within that rectangle, and

h) Output the final image as a memory stream in an image format.

For all embodiments described herein, image enhancing techniques may be used to adjust the image.

While various implementations and embodiments of have been described, it will be apparent to those of ordinary skill in the art that many more are possible.

What is claimed is:

1. A system for isolating an image of a target property comprising:
a user interface apparatus for receiving a property identifier;
a virtual tile retriever for retrieving a set of virtual tiles from a source of virtual tile images using said property identifier;
an image isolator for generating an isolated image of the target property from the set of virtual tiles; and
an output device for displaying said isolated image of the target property.
